(19) United States
(12) Patent Application Publication
(10) Pub. No.: US 2021/0292464 A1
(43) Pub. Date: Sep. 23, 2021

(54) SELF-HEALING COMPOSITION

(71) Applicants: CENTRE NATIONAL DE LA RECHERCHE SCIENTIFIQUE, PARIS (FR); SORBONNE UNIVERSITE, PARIS (FR)

(72) Inventors: Laurent BOUTEILLER, BOURG LA REINE (FR); Léo SIMONIN, PARIS (FR); Sandrine PENSEC, VAUHALLAN (FR); Francois GANACHAUD, DECINES-CHARPIEU (FR); Roman BRONIMANN, MOUTHIER EN BRESSE (FR); Laura LUIZ, PARIS (FR)

(21) Appl. No.: 17/264,781

(22) PCT Filed: Jul. 30, 2019
(86) PCT No.: PCT/FR2019/051869

§ 371 Date: Jan. 29, 2021

(30) Foreign Application Priority Data
Aug. 1, 2018 (FR) 1857196

(51) Int. Cl. C08G 18/61; C08G 77/458; C08G 77/452; C08G 18/75

(52) U.S. Cl. CPC C08G 18/61; C08G 18/755; C08G 77/452; C08G 77/458

(57) ABSTRACT

The invention relates to a self-healing composition based on at least one elastomer matrix comprising a segment chosen from polysiloxanes, polyesters, polyethers, polycarbonates and polyolefins and a polyurea or polyurethane segment and on at least one polymer material as healing additive, to its process of preparation, to its uses, to an electrical and/or optical cable comprising a layer obtained from said composition, and to a specific healing additive.

The invention relates to a self-healing composition based on at least one elastomer matrix comprising a segment chosen from polysiloxanes, polyesters, polyethers, polycarbonates and polyolefins and a polyurea or polyurethane segment and on at least one polymer material as healing additive, to its process of preparation, to its uses, to an electrical and/or optical cable comprising a layer obtained from said composition, and to a specific healing additive.

Polymer materials, during their serviceable life, generally undergo numerous stresses which can be mechanical, thermal or also chemical in nature. These stresses damage the materials, weaken them and sometimes render them unusable. It is known to use polymer materials which self-heal or self-repair when they are subjected to external damage, such as cuts, lesions and/or cracks. The two most well-known strategies comprise the inclusion of reactive compounds (exogenous agents), which are released at the time of the lesion and react in order to repair the properties of the material (assisted healing), and the incorporation of reversible bonds, such as those based on multiple hydrogen bonds; the material then has the intrinsic ability to heal. However, this process generally requires an external stimulus, an element which makes it possible to trigger the repairing: an additive, such as water or a solvent, an input voltage, heat, light, an external pressure, or also specific environmental conditions, such as a specific pH level.

Research studies have thus concentrated on a polymer capable of bringing to completion, and spontaneously, a quantitative recovery, without the presence of the least external stimulus. In particular, EP 2 785 765 B1 describes a polyurethane or silicone elastomer having self-healing properties. The elastomer described comprises a polymer chain functionalized with at least two sulfur atoms in the thiol or thiolate form or forming part of a disulfide. However, these elastomers have mechanical properties which are inadequate, in particular in terms of breaking stress and elongation at break, for many applications using rubbers.

Furthermore, silicone supramolecular elastomer materials have in recent years attracted particular attention for their elastomer properties and their good high-temperature electrical resistance, while guaranteeing good mechanical properties, in particular in terms of Young's modulus, of breaking stress and of elongation at break. “Supramolecular” materials exhibit the advantage of comprising “reversible” (nonpermanent) intermolecular bonds, unlike polymers resulting from conventional chemistry, which are based on “irreversible” (permanent) bonds. The “reversible” bonds can be hydrogen, ionic and/or hydrophobic bonds. Unlike conventional silicone elastomer materials, these silicone supramolecular elastomer materials thus have the advantage of being able to liquefy above a certain temperature, which makes them easier to process, and also to recycle. Such silicone supramolecular elastomers are described, for example, by Yilgör et al., Polymer, 2001, 42, 7953-7959. However, such elastomers do not have self-healing properties at ambient temperature.

The aim of the invention is thus to overcome all or some of the disadvantages of the prior art, and to provide a material which is self-healing, in particular at ambient temperature, can be easily recycled and has good mechanical properties, in particular in terms of Young's modulus, of elongation at break and of breaking stress.

Another aim of the invention is to provide a simple, easily industrializable, economic and environmentally friendly process for the preparation of said material.

These aims are attained by the invention which will be described below.

A first subject-matter of the invention is thus a self-healing composition comprising at least one elastomer matrix corresponding to the following formula (I):

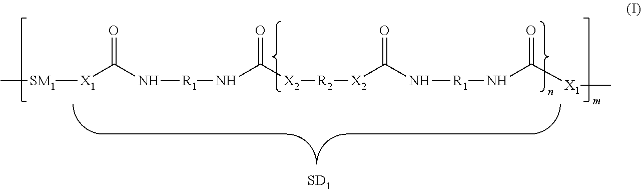

in which:
m and n are such that the molar mass of the elastomer matrix of formula (I) is between 2 and 200 kg/mol approximately,
SM₁ is a segment chosen from polysiloxanes, polyesters, polyethers, polycarbonates and polyolefins,

said segment SM₁ being combined with a polyurea or polyurethane segment SD₁, in which:
R₁ is a divalent alkylene, arylene or aralkylene group comprising from 3 to 20 carbon atoms,
R₂ is a divalent alkylene, arylene or aralkylene group comprising from 1 to 30 carbon atoms, said group optionally comprising one or more heteroatoms chosen from an oxygen atom, a sulfur atom or a halogen atom,
X₁ and X₂, which are identical, are oxygen —O— atoms or amine —NH-groups, and
n≥0,

characterized in that it additionally comprises a polymer material corresponding to the following formula (II):

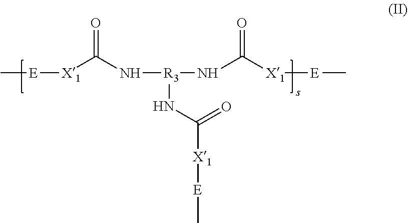

in which:
0≤s≤10,
R₃ is an at least trivalent alkylene, arylene or aralkylene group comprising from 3 to 30 carbon atoms, said R₃ group optionally comprising one or more heteroatoms chosen from an oxygen atom, a nitrogen atom and one of their mixtures, it being possible for said R₃ group to be substituted by 1, 2 or 3 additional —NH—C(═O)X′₁-E groups,
X′₁ is an oxygen —O— atom, an amine —NH— group or an amine —NR₄-group, R₄ being an alkyl group comprising from 1 to 12 carbon atoms, a benzyl group, an allyl group, or an alkylene group such that X′₁ and the X₃ group as defined below together form a ring, and
E corresponds to the following formula (II′):

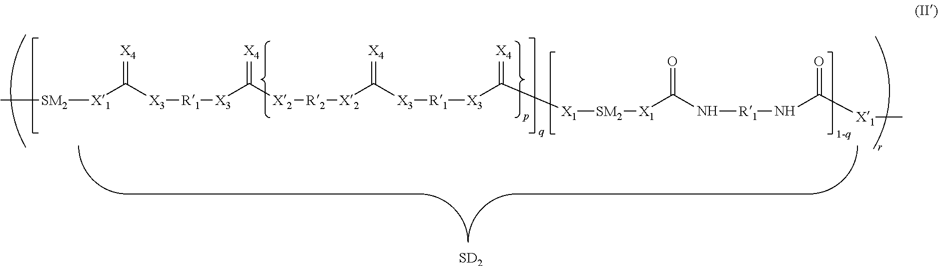

in which:
SM₂ is a segment chosen from polysiloxanes, polyesters, polyethers, polycarbonates and polyolefins,

said segment SM₂ being combined with a segment SD₂, in which:
R′₁ is a divalent alkylene, arylene or aralkylene group comprising from 3 to 20 carbon atoms,
R′₂ is a divalent alkylene, arylene or aralkylene group comprising from 1 to 30 carbon atoms, said group optionally comprising one or more heteroatoms chosen from an oxygen atom, a sulfur atom or a halogen atom,
X₁ is as defined above for the formula (I),
X′₁ is as defined above for the formula (II),
X′₂ is an oxygen —O— atom, an amine —NH— group or an amine —NR₅— group, R₅ being an alkyl group comprising from 1 to 12 carbon atoms, a benzyl group or an allyl group,
X₃ is an amine —NH— group or an amine —NR₆— group, R₆ being an alkyl group comprising from 1 to 12 carbon atoms, a benzyl group or an allyl group,
X₄ is an oxygen atom or a sulfur atom,
p≥0,
0<q≤1, and
p, q, r and s are such that the molar mass of the polymer material of formula (II) is between 1 and 200 kg/mol approximately,

said elastomer matrix (I) and said polymer material (II) being such that:
when X₁ is an amine —NH— group, X′₁ is other than an oxygen —O— atom, X′₂ is other than an oxygen —O— atom when p≠0, and at least one of the following definitions applies:
X₄ is a sulfur atom,
X′₁ is an amine —NR₄— group,
X′₂ is an amine —NR₅— group and p≠0,
X₃ is an amine —NR₆— group,
when X₁ is an oxygen —O— atom, X′₁ is an oxygen —O— atom, X′₂ is an oxygen —O— atom when p≠0, and at least one of the following definitions applies:
X₄ is a sulfur atom,
X₃ is an amine —NR₆— group.

A second subject-matter of the invention is also a self-healing composition comprising at least one elastomer matrix corresponding to the formula (I) as defined in the first subject-matter of the invention and a polymer material corresponding to the following formula (IIa):

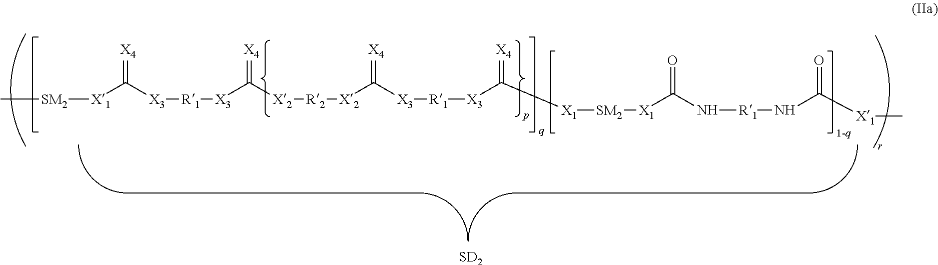

in which:
SM₂ is as defined for the formula (II), said segment SM₂ being combined with a segment SD₂, in which:
R′₁ is as defined for the formula (II),
R′₂ is as defined for the formula (II),
X′₁ is an oxygen —O— atom, an amine —NH— group, an amine —NR₄-group, or a mixture of an amine —NH— group and of an amine —NR₄— group, R₄ being as defined for the formula (II),
X′₂ is an oxygen —O— atom, an amine —NH— group, an amine —NR₅— group, or a mixture of an amine —NH— group and of an amine —NR₅— group, R₅ being as defined for the formula (II),
X₃ is an amine —NH— group, an amine —NR₆— group, or a mixture of an amine —NH— group and of an amine —NR₆— group, R₆ being as defined for the formula (II),
X₄ is an oxygen atom or a sulfur atom, and preferably an oxygen atom,
p is as defined for the formula (II),
q=1, and
p and r are such that the molar mass of the polymer material of formula (IIa) is between 1 and 200 kg/mol approximately,

said elastomer matrix (I) and said polymer material (IIa) being such that:
when X₁ is an amine —NH— group, X′₁ is other than an oxygen —O— atom, X′₂ is other than an oxygen —O— atom when p≠0, and at least one of the following definitions applies:
X′₁ is a mixture of an amine —NH— group and of an amine —NR₄— group,
X′₂ is a mixture of an amine —NH— group and of an amine —NR₅— group, and p≠0,
X₃ is a mixture of an amine —NH— group and of an amine —NR₆— group,
when X₁ is an oxygen —O— atom, X′₁ is an oxygen —O— atom, X′₂ is an oxygen —O— atom when p≠0, and X₃ is a mixture of an amine —NH— group and of an amine —NR₆— group.

By virtue of the combination of an elastomer matrix of formula (I) and of a polymer material of formula (II) or (IIa), the composition of the invention exhibits self-healing properties at ambient temperature: a (micro)crack or a break occurring in this composition can be repaired at ambient temperature, in particular using simple contact of the two fracture surfaces, under a light pressure, without it being necessary to adhesively bond or to heat. Furthermore, the self-healing composition of the invention can be easily recycled and exhibits good mechanical properties, in particular in terms of Young's modulus, of elongation at break and of breaking stress.

In the present invention, the molar mass of the polymer or elastomer compounds as are described below is preferably determined by the size exclusion chromatography (SEC) method.

In the present invention, the values m, n, p, q, r and s are made explicit or are deduced from the molar masses of the compounds of formulae (I), (II) and (IIa).

The Elastomer Matrix (I)

The elastomer matrix (I) preferably has a molar mass of between 20 and 100 kg/mol approximately.

The segment SM₁ is generally known as soft segment or block, referred to as supple or flexible, as it contributes the elastomer properties to the matrix. A contrario, the segment SD₁ of the elastomer matrix of formula (I) is a hard segment or block, referred to as rigid, and it contributes the thermoplastic properties. The combination of the segments SM₁ and SD₁ within the elastomer matrix (I) makes it possible to obtain good mechanical properties.

The segment SM₁ is chosen from polysiloxanes, polyesters, polyethers, polycarbonates and polyolefins.

Mention may be made, as examples of polyesters, of a polycaprolactone or a poly(butanediol succinate).

Mention may be made, as examples of polyethers, of a poly(ethylene oxide), a poly(propylene oxide) and a poly(butylene oxide).

Mention may be made, as examples of polycarbonates, of a poly(trimethylene carbonate).

Mention may be made, as examples of polyolefins, of a polyisobutene, a poly(ethylene-butylene) or a polybutadiene.

Mention may be made, as examples of polysiloxanes, of a methylated, fluorinated, phenylated or vinylated polysiloxane or one of their copolymers.

The segment SM₁ is preferably chosen from polysiloxanes and polyethers.

According to a first alternative form, the segment SM₁ is chosen from polysiloxanes and more preferably polydimethylsiloxanes.

According to a second alternative form, the segment SM₁ is chosen from polyethers.

The alkylene group, within the meaning of the present invention, can be linear (i.e. unsubstituted) or branched (i.e. substituted), cyclic (i.e. comprising at least one ring) or noncyclic (i.e. not comprising a ring).

The alkyl group, within the meaning of the present invention, can be linear (i.e. unsubstituted) or branched (i.e. substituted), cyclic (i.e. comprising at least one ring) or noncyclic (i.e. not comprising a ring).

The arylene group, within the meaning of the present invention, can be mono- or polysubstituted.

The aralkylene group, within the meaning of the present invention, can be a group comprising at least one alkylene radical and at least one arylene radical, said alkylene and arylene radicals being connected by a carbon-carbon, carbon-nitrogen, carbon-oxygen or carbon-sulfur bond.

The alkylene R₁ group preferably comprises from 3 to 16 carbon atoms and more preferably from 5 to 15 carbon atoms. Linear alkylene groups having from 3 to 10 carbon atoms and cyclic groups having from 5 to 15 carbon atoms are preferred.

The arylene R₁ group preferably comprises from 4 to 16 carbon atoms and more preferably from 5 to 12 carbon atoms. The mono- or disubstituted phenylene group, in particular substituted by one or more methyl groups, is preferred.

The aralkylene R₁ group preferably comprises from 3 to 16 carbon atoms and more preferably from 5 to 15 carbon atoms.

In the aralkylene R₁ group, the arylene radical can comprise from 4 to 20 carbon atoms and preferably from 5 to 15 carbon atoms, and the alkylene group can comprise from 1 to 10 carbon atoms and preferably from 1 to 6 carbon atoms.

The aralkylene groups comprising two phenylene groups connected by an alkylene group or comprising two alkylene groups connected by a phenylene group are preferred.

According to a preferred embodiment of the invention, the R₁ group is chosen from the following formulae:

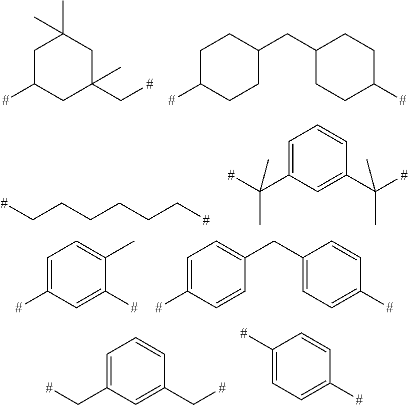

in which the # signs represent the points of attachment of the R₁ radical to the NH radicals in the formula (I).

According to a particularly preferred embodiment of the invention, the R₁ group is chosen from the following formulae:

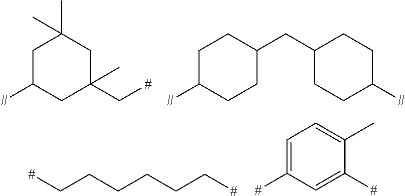

in which the # signs represent the points of attachment of the R₁ radical to the NH radicals in the formula (I).

The alkylene R₂ group preferably comprises from 1 to 20 carbon atoms and more preferably from 2 to 12 carbon atoms. Cyclic or linear alkylene groups, optionally comprising one or more oxygen atoms, are preferred.

The arylene R₂ group preferably comprises from 4 to 16 carbon atoms and more preferably from 5 to 12 carbon atoms.

The phenylene group, optionally substituted by one or more halogen atoms, such as chlorine atoms, or by one or more alkyl groups having from 1 to 5 carbon atoms, it being possible for said alkyl groups to comprise one or more sulfur or oxygen atoms, is preferred.

The aralkylene R₂ group preferably comprises from 5 to 30 carbon atoms and more preferably from 8 to 25 carbon atoms.

In the aralkylene R₂ group, the arylene radical can comprise from 4 to 20 carbon atoms and preferably from 5 to 15 carbon atoms, and the alkylene group can comprise from 1 to 10 carbon atoms and preferably from 1 to 6 carbon atoms.

The aralkylene groups comprising two phenylene groups connected by an alkylene group or comprising two alkylene groups connected by a phenylene group are preferred. The phenylene group can be substituted by one or more halogen atoms, such as chlorine atoms. The alkylene group can comprise one or more sulfur or oxygen atoms.

According to a particularly preferred embodiment of the invention,
when X₂ is an amine —NH— group, R₂ is chosen from an alkylene group comprising from 2 to 12 carbon atoms and the groups having the following formulae:

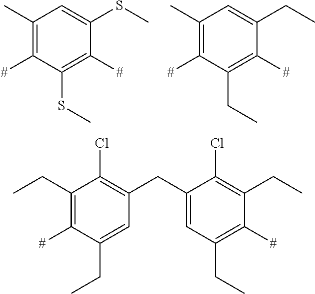

in which the # signs represent the points of attachment of the R₂ radical to the X₂ radicals,
when X₂ is an oxygen —O— atom, R₂ is chosen from an alkylene group comprising from 2 to 12 carbon atoms and the groups having the following formulae:

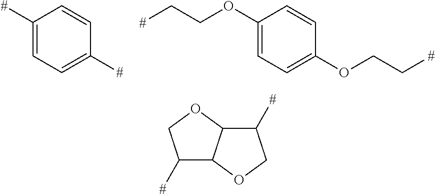

in which the # signs represent the points of attachment of the R₂ radical to the X₂ radicals.

In the elastomer matrix of formula (I), n can be equal to zero (absence of a chain extender) or greater than zero (presence of a chain extender). The presence of a chain extender makes it possible to increase the proportion of segments SD₁, and thus advantageously to adjust the mechanical properties of the composition, in particular to improve its Young's modulus.

In the elastomer matrix of formula (I), the ratio: molar mass segment SD₁/(molar mass segment SD₁+molar mass segment SM₁), varies from 0.01 to 0.6 approximately, and preferably from 0.05 to 0.5 approximately. Such a ratio makes it possible to obtain good mechanical properties, in particular in terms of Young's modulus.

The Polymer Material (II) or the Polymer Material (IIa)

The polymer material (II) [respectively the polymer material (IIa)] preferably has a molar mass of between 10 and 50 kg/mol approximately. With this molar mass, a good compromise is obtained in terms of self-healing and of mechanical properties.

The segment SM₂ is generally known as soft segment or block, referred to as supple or flexible, and it contributes the elastomer properties to the material. A contrario, the segment SD₂ of the polymer material of formula (II) [respectively of the polymer material (IIa)] is a hard segment or block, referred to as rigid, and it contributes the thermoplastic properties.

The segment SM₂ is chosen from polysiloxanes, polyesters, polyethers, polycarbonates and polyolefins.

Mention may be made, as examples of polyesters, of a polycaprolactone or a poly(butanediol succinate).

Mention may be made, as examples of polyethers, of a poly(ethylene oxide), a poly(propylene oxide) or a poly(butylene oxide).

Mention may be made, as examples of polycarbonates, of a poly(trimethylene carbonate).

Mention may be made, as examples of polyolefins, of a polyisobutene, a poly(ethylene-butylene) or a polybutadiene.

Mention may be made, as examples of polysiloxanes, of a methylated, fluorinated, phenylated or vinylated polysiloxane or one of their copolymers.

The segment SM₂ is preferably chosen from polysiloxanes and polyethers.

According to a first alternative form, the segment SM₂ is chosen from polysiloxanes and more preferably polydimethylsiloxanes.

According to a second alternative form, the segment SM₂ is chosen from polyethers.

Preference is given, as alkyl R₄ group for the amine —NR₄— group of X′₁, to an alkyl group comprising from 1 to 6 carbon atoms, such as a methyl, ethyl or propyl group, and more preferably an ethyl group.

The alkylene R′₁ group preferably comprises from 3 to 16 carbon atoms and more preferably from 5 to 15 carbon atoms. Linear alkylene groups having from 3 to 10 carbon atoms and cyclic groups having from 5 to 15 carbon atoms are preferred.

The arylene R′₁ group preferably comprises from 4 to 16 carbon atoms and more preferably from 5 to 12 carbon atoms. The mono- or disubstituted phenylene group, in particular substituted by one or more methyl groups, is preferred.

The aralkylene R′₁ group preferably comprises from 3 to 16 carbon atoms and more preferably from 5 to 15 carbon atoms.

In the aralkylene R′₁ group, the arylene radical can comprise from 4 to 20 carbon atoms and preferably from 5 to 15 carbon atoms, and the alkylene group can comprise from 1 to 10 carbon atoms and preferably from 1 to 6 carbon atoms.

The aralkylene groups comprising two phenylene groups connected by an alkylene group or comprising two alkylene groups connected by a phenylene group are preferred.

According to a preferred embodiment of the invention, the R′₁ group is chosen from the following formulae:

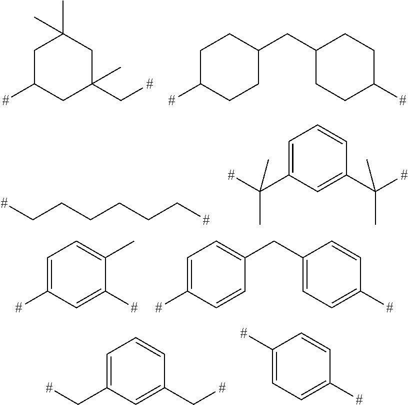

in which the # signs represent the points of attachment of the R′₁ radical to the NH and X₃ radicals in the formula (II) or the points of attachment of the R′₁ radical to the X₃ radicals in the formula (IIa).

According to a particularly preferred embodiment of the invention, the R′₁ group is chosen from the following formulae:

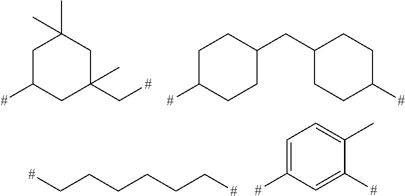

in which the # signs represent the points of attachment of the R′₁ radical to the NH and X₃ radicals in the formula (II) or the points of attachment of the R′₁ radical to the X₃ radicals in the formula (IIa).

The R₁ and R′₁ groups can be identical or different, and preferably identical.

The alkylene R′₂ group preferably comprises from 1 to 20 carbon atoms and more preferably from 2 to 12 carbon atoms. Cyclic or linear alkylene groups, optionally comprising one or more oxygen atoms, are preferred.

The arylene R′₂ group preferably comprises from 4 to 16 carbon atoms and more preferably from 5 to 12 carbon atoms.

The phenylene group, optionally substituted by one or more halogen atoms, such as chlorine atoms, or by one or more alkyl groups having from 1 to 5 carbon atoms, it being possible for said alkyl groups to comprise one or more sulfur or oxygen atoms, is preferred.

The aralkylene R′₂ group preferably comprises from 5 to 30 carbon atoms and more preferably from 8 to 25 carbon atoms.

In the aralkylene R′₂ group, the arylene radical can comprise from 4 to 20 carbon atoms and preferably from 5 to 15 carbon atoms, and the alkylene group can comprise from 1 to 10 carbon atoms and preferably from 1 to 6 carbon atoms.

The aralkylene groups comprising two phenylene groups connected by an alkylene group or comprising two alkylene groups connected by a phenylene group are preferred. The phenylene group can be substituted by one or more halogen atoms, such as chlorine atoms. The alkylene group can comprise one or more sulfur or oxygen atoms.

According to a particularly preferred embodiment of the invention,
when X′₂ is an amine —NH— and/or —NR₅— group (e.g., an amine —NH— or —NR₅— group for the formula (II)), R′₂ is chosen from an alkylene group comprising from 2 to 12 carbon atoms and the groups having the following formulae:

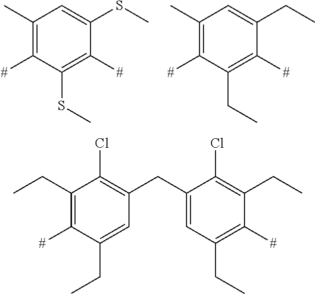

in which the # signs represent the points of attachment of the R′₂ radical to the X′₂ radicals,
when X′₂ is an oxygen —O— atom, R′₂ is chosen from an alkylene group comprising from 2 to 12 carbon atoms and the groups having the following formulae:

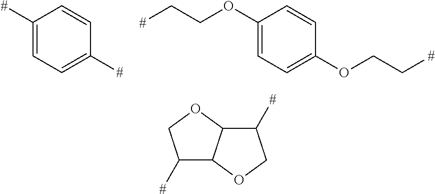

in which the # signs represent the points of attachment of the R′₂ radical to the X′₂ radicals.

In the polymer material of formula (II) or (IIa), p can be equal to zero (absence of a chain extender) or greater than zero (presence of a chain extender). The presence of a chain extender makes it possible to increase the proportion of segments SD₂, and thus advantageously to adjust the mechanical properties of the composition, in particular to improve its Young's modulus.

The R₂ and R′₂ groups can be identical or different, and preferably identical.

Preference is given, as alkyl R₅ group for the amine —NR₅— group of X′₂, to an alkyl group comprising from 1 to 6 carbon atoms, such as a methyl, ethyl or propyl group, and more preferably a methyl group.

Preference is given, as alkyl R₆ group for the amine —NR₆— group of X₃, to an alkyl group comprising from 1 to 6 carbon atoms, such as a methyl, ethyl or propyl group, and more preferably a methyl group.

In the polymer material of formula (II) or of formula (IIa), the ratio: molar mass segment SD₂/(molar mass segment SD₂+molar mass segment SM₂), varies from 0.01 to 0.6 approximately, and preferably from 0.05 to 0.5 approximately. Such a ratio makes it possible to obtain healing at ambient temperature, while guaranteeing good mechanical properties, in particular in terms of Young's modulus.

The Polymer Material of Formula (II)

In the polymer material of formula (II), s is such that 0≤s≤10, and s is preferably equal to zero.

In the polymer material of formula (II), q is such that 0<q≤1, and preferably q=1.

The R₃ group optionally comprises one or more heteroatoms chosen from an oxygen atom, a nitrogen atom and one of their mixtures, in particular in the form of one or more amide, ester, urethane or urea functional groups.

The alkylene R₃ group preferably comprises from 3 to 24 carbon atoms and more preferably from 6 to 24 carbon atoms. Branched alkylene groups, in particular those comprising at least one amide or ester functional group capable of connecting the trivalent R₃ group to the —NH— radicals of the formula (II), are preferred.

The arylene R₃ group preferably comprises from 4 to 16 carbon atoms and more preferably from 5 to 12 carbon atoms. The phenylene group, optionally substituted by one or more alkyl groups having from 1 to 5 carbon atoms, it being possible for the alkyl groups to be substituted by one or more nitrogen or oxygen atoms or one of their mixtures, is preferred.

The aralkylene R₃ group preferably comprises from 5 to 30 carbon atoms and more preferably from 8 to 25 carbon atoms.

In the aralkylene R₃ group, the arylene radical can comprise from 4 to 20 carbon atoms and preferably from 5 to 15 carbon atoms, and the alkylene group can comprise from 1 to 10 carbon atoms and preferably from 1 to 6 carbon atoms.

The aralkylene groups comprising three phenylene groups connected by an alkylene group or comprising three alkylene groups connected by a phenylene group are preferred. The alkylene and phenylene groups can, independently of one another, be substituted by one or more nitrogen or oxygen atoms or one of their mixtures.

According to a particularly preferred embodiment of the invention, R₃ is chosen from an alkylene group comprising from 3 to 24 carbon atoms and the groups having the following formulae:

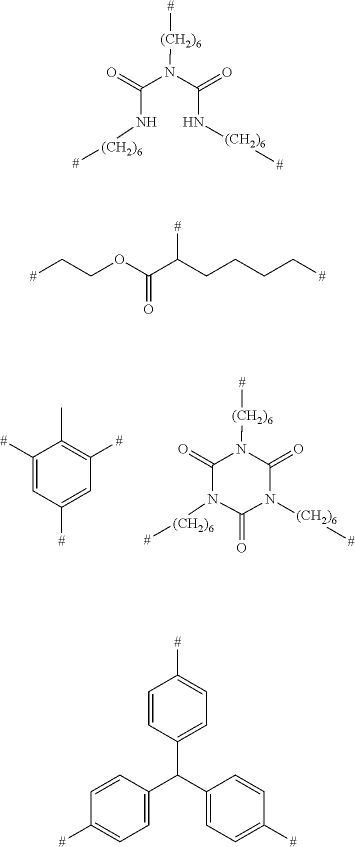

in which the # signs represent the points of attachment of the R₃ radical to the —NH— radicals.

When R₄ is an alkylene group such that X′₁ and X₃ together form a ring, R₄ is preferably a linear alkylene group comprising 2 or 3 carbon atoms.

According to a first alternative form, the R₅ group for the amine —NR₅— group of X′₂ is an alkyl group as defined in the invention.

According to a second alternative form, the R₅ group for the amine —NR₅— group of X′₂ is a benzyl or allyl group.

According to a first alternative form, the R₆ group for the amine —NR₆— group of X₃ is an alkyl group as defined in the invention.

According to a second alternative form, the R₆ group for the amine —NR₆— group of X₃ is a benzyl or allyl group.

According to a first preferred embodiment of the invention, the material of formula (II) is such that X₁ is an amine —NH— group, X′₁ is other than an oxygen —O— atom, X′₂ is other than an oxygen —O— atom when p≠0, and X₄ is a sulfur atom and/or X′₁ is an amine —NR₄— group.

According to this first embodiment of the invention, the elastomer matrix (I) and the polymer material (II) can advantageously be such that:
X₁ is an amine —NH— group, X′₁ is an amine —NH— or —NR₄— group, and preferably an amine —NH— group, X₃ is an amine —NH— or —NR₆— group, and preferably an amine —NH— group, and X₄ is a sulfur atom, or
X₁ is an amine —NH— group, X′₁ is an amine —NR₄— group, X₃ is an amine —NH— or —NR₆— group, and preferably an amine —NH— group, and X₄ is an oxygen atom.

In this first embodiment, p=0, or p≠0 and X′₂ is an amine —NH— or —NR₅— group, and preferably an amine —NH— group.

Still in this first embodiment, SM₁ and SM₂ are preferably chosen from polysiloxanes and polyethers.

According to a second preferred embodiment of the invention, the material of formula (II) is such that X₁ is an oxygen —O— atom, X′₁ is an oxygen —O— atom, X′₂ is an oxygen —O— atom when p≠0, and X₃ is an amine —NR₆— group.

In this second embodiment of the invention, the elastomer matrix (I) and the polymer material (II) can advantageously be such that X₁ is an oxygen —O— atom, X′₁ is an oxygen —O— atom, X₃ is an amine —NR₆— group, and X₄ is an oxygen atom.

In this second embodiment, p=0, or p≠0 and X′₂ is an oxygen —O— atom.

Still in this second embodiment, SM₁ and SM₂ are preferably chosen from polyesters, polyethers and polyolefins.

The Polymer Material of Formula (IIa)

Such a compound of formula (IIa) exhibits, like the compound of formula (II), healing properties.

In the invention, mixture of an amine —NH— group and of an amine —NR₄—, —NR₅— or —NR₆— group is understood to mean the presence, on some parts or units of the polymer material (IIa), of an amine —NH— group, and the presence, on other units or parts of the same polymer material (IIa), of an amine —NR₄—, —NR₅— or —NR₆— group. In other words, at least one of the R₄, R₅ or R₆ groups is distributed statistically in the chain of the polymer material (IIa). Reference is then made to degree of substitution.

In the polymer material of formula (IIa), the degree of substitution T₄ relative to the R₄ group, the degree of substitution T₅ relative to the R₅ group and the degree of substitution T₆ relative to the R₆ group are such that 0%≤T₄≤100%, 0%≤T₅≤100% and 0%≤T₆≤100%, it being understood that at least one of said degrees T₄, T₅ or T₆ is strictly greater than 0% and strictly less than 100%. A degree of substitution Tₓ of 100% means that all the amine groups are substituted in the polymer material (IIa) and that there is thus not a mixture of amine —NH— and —NR₄— groups, or a mixture of amine —NH— and —NR₅— groups, or a mixture of amine —NH— and —NR₆— groups.

In a preferred embodiment, the degree of substitution T₄, T₅ or T₆ ranges from 30% to 70% approximately.

The degree of substitution can be determined by an NMR analysis, in particular by the presence of the peaks of the R₄, R₅ or R₆ groups in the polymer material of formula (IIa).

According to a particularly preferred embodiment, X′₁ is an oxygen —O— atom, X′₂ is an oxygen —O— atom when p≠0, and X₃ is a mixture of an amine —NH— group and of an amine —NR₆— group.

The Composition in Accordance with the First or with the Second Subject-Matter of the Invention

In the composition of the invention, the polymer material (II) [respectively the polymer material (IIa)] preferably represents from 0.1% to 100% by weight approximately, preferably from 0.5% to 50% by weight approximately and more preferably from 1% to 20% by weight approximately, with respect to the total weight of the elastomer matrix (I). With these proportions, a good compromise is obtained in terms of self-healing and of mechanical properties.

The composition can additionally comprise at least one inorganic filler, in particular chosen from silica, preferentially in the form of quartz, talc, calcium carbonate, carbon black and one of their mixtures. The inorganic filler can make it possible to reinforce the mechanical properties of the composition.

Silica, in particular quartz, as inorganic filler is preferred.

The inorganic filler can represent from 1% to 70% by weight approximately, with respect to the total weight of the elastomer matrix (I), and preferably from 5% to 30% by weight approximately, with respect to the total weight of the elastomer matrix (I).

Preferably, the segments SM₁ and SM₂ in the composition are of the same chemical nature. In other words, they can be together polysiloxanes, polyesters, polyethers, polycarbonates or polyolefins, preferably polysiloxanes or polyethers.

The composition of the invention preferably exhibits a Young's modulus varying from 0.5 to 50 MPa approximately and more preferably from 0.5 to 20 MPa approximately.

The composition of the invention preferably exhibits a breaking stress varying from 0.1 to 20 MPa approximately and more preferably from 0.2 to 5 MPa approximately.

The composition of the invention preferably exhibits an elongation at break varying from 50% to 2000% approximately and more preferably from 60% to 1200% approximately.

A third subject-matter of the invention is also a process for the preparation of a composition in accordance with the first or with the second subject-matter of the invention, characterized in that it comprises at least one stage of mixing the elastomer (I) with the polymer material (II) or the polymer material (IIa), by the solvent route or by the molten route.

In particular, when the mixing is carried out by the solvent route, the mixing stage comprises the following substages:
preparing a solution comprising the elastomer of formula (I) in a solvent S₁,
preparing a solution comprising the polymer material of formula (II) in a solvent S₂,
mixing the preceding solutions, in particular with mechanical stirring,
spreading the resulting solution over a substrate or pouring it into a mould,
evaporating the solvents S₁ and S₂, and
drying the resulting mixture, in particular in the open air and/or under vacuum.

The solvent S₁ can be chosen from tetrahydrofuran, acetone, diacetone alcohol, dichloromethane, toluene and one of their mixtures.

The solvent S₂ can be chosen from tetrahydrofuran, acetone, diacetone alcohol, dichloromethane, toluene and one of their mixtures.

The solvents S₁ and S₂ are preferably identical.

The resulting mixture obtained can be shaped, in particular by spraying the abovementioned resulting solution over said support, or by drawing with a film applicator.

When the mixing is carried out by the molten route, the mixing stage comprises the following substages:
heating the elastomer (I) with the polymer material (II) or with the polymer material (IIa) at a temperature greater than their softening points, and
homogenizing the resulting mixture, in particular by shearing it, in particular using an internal mixer or an extruder.

The elastomer (I) can be prepared by polyaddition of at least one diisocyanate with at least one polymer chosen from polysiloxanes, polyesters, polyethers, polycarbonates and polyolefins, optionally in the presence of a catalyst.

The polymer has in particular end functional groups making possible polyaddition with the diisocyanate, such as amine functional groups or alcohol functional groups.

The diisocyanate can be chosen from 2,4-toluene diisocyanate, 4,4′-diphenylmethane diisocyanate, 1,6-hexamethylene diisocyanate, isophorone diisocyanate, m-xylylene diisocyanate, 1,4-phenylene diisocyanate, 1,3-bis(1-isocyanato-1-methylethyl)benzene and 1,1′-methylenebis(4-isocyanatocyclohexane).

The polymer material (II) or (IIa) can be prepared according to the same processes as those as defined above for the preparation of the elastomer (I).

A fourth subject-matter of the invention is the use of a polymer material corresponding to the formula (II) or (IIa) as defined in the first or second subject-matter of the invention, as healing additive for an elastomer corresponding to the formula (I) as defined in the first subject-matter of the invention.

This is because, by virtue of the addition of a polymer material corresponding to the formula (II) as defined in the first subject-matter of the invention or of a polymer material corresponding to the formula (IIa) as defined in the second subject-matter of the invention to a composition comprising at least one elastomer corresponding to the formula (I) as defined in the first subject-matter of the invention, the composition acquires self-healing properties, in particular at ambient temperature, without damaging the mechanical properties of the elastomer matrix (I).

Furthermore, by virtue of the addition of a polymer material of formula (II) or (IIa), the composition according to the invention exhibits self-healing characteristics without any external stimuli (temperature, pressure, and the like) being necessary.

A fifth subject-matter of the invention is the use of a composition in accordance with the first or with the second subject-matter of the invention as self-healing material, in particular at ambient temperature.

A sixth subject-matter of the invention is the use of a composition in accordance with the first or with the second subject-matter of the invention in the manufacture of seals, in particular of leaktight seals, of coatings, of materials for the damping of vibrations, or of insulating materials for electrical and/or optical cables.

The compositions of the invention can also be used in the manufacture of conveyor belts, of anti-impact protection, of occupational gloves, of coatings, in particular corrosion-resistant coatings, of metals or of additives in the field of adhesives, asphalts, organic binders, paints, varnishes, pastes and mastics.

A seventh subject-matter of the invention is an electrical and/or optical cable comprising at least one electrical and/or optical conducting element and at least one polymer layer surrounding the electrical and/or optical conducting element, characterized in that the polymer layer is obtained from a composition in accordance with the first or with the second subject-matter of the invention.

An eighth subject-matter of the invention is a healing additive, characterized in that it is a polymer material corresponding to the formula (II) as defined in the first subject-matter of the invention and in which X′₁ is an amine N-ethyl, N-benzyl or N-allyl group, and preferably an N-ethyl group, X₃ is an amine —NH— group, SM₂ is a polydimethylsiloxane segment and X₄ is an oxygen atom.

Other characteristics and advantages of the present invention will become apparent in the light of the examples which will follow, said examples being given for illustrative purposes and not being in any way limiting.

### EXAMPLES

In the examples, the molar mass of the polymers was measured by the “SEC” (Size Exclusion Chromatography) method.

Size exclusion chromatography (SEC) measurements were carried out with three PL Gel Mixte C using 5 μm columns (commercial product from Agilent) (7.5×300 mm; having separation limits: 0.2 to 2000 kg·mol⁻¹) maintained at 40° C., which are coupled to a solvent distribution module and to a Viscotek 3580 differential refractive index (RI) detector of samples. The mobile phase used is composed of THF, at a flow rate of 1 ml·min⁻¹, and toluene was used as flow rate marker. All the polymers according to the invention were injected (100 μl) at a concentration of 5 mg·ml⁻¹ after filtration through a 0.45 μm membrane. An OmniSEC data analysis device was used for the acquisition and the analysis of the data. The molar masses (Mn, number-average molar mass, Mw, weight-average molar mass) and the dispersity (=Mw/Mn) were derived from a calibration curve based on the polystyrene (PS) standards from Polymer Standards Service.

Other techniques than the SEC technique for determining the molar mass of the compositions according to the invention and known to a person skilled in the art of the field of polymers can be envisaged.

### Example 1: Preparation of a Self-Healing Composition C1 in Accordance with the Invention

1.1 Preparation of a Polymer Material Corresponding to the Formula (II-1)

A polymer material of following formula (II-1):

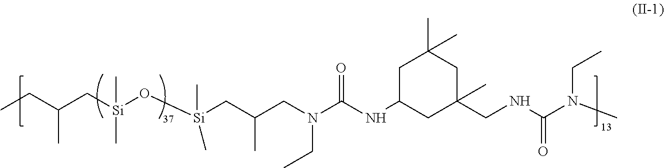

was prepared in the following way:

Isophorone diisocyanate (IPDI; 0.78 mmol) was dissolved at ambient temperature under an inert atmosphere (N₂) in 20 ml of anhydrous tetrahydrofuran (THF) in a round-bottomed reaction flask, and then a polydimethylsiloxane substituted in the end positions by N-ethylaminoisobutyl (DMS-A214; 0.78 mmol) was added to the round-bottomed flask, as well as a catalytic amount of triethylamine. The solution was subsequently stirred for 12 days. The completion of the reaction was confirmed by infrared spectroscopy by the disappearance of the absorption peak of the isocyanate. Once the reaction was finished, the solvent was evaporated. The product obtained was then dissolved in 20 ml of dichloromethane and then washed with 3×10 ml of distilled water. The resulting organic phase was dried under vacuum (10⁻³ mbar) at 70° C. for 2 days. 1.8 g of product were obtained (87% yield).

1.2 Preparation of the Self-Healing Composition C1

In order to prepare the self-healing composition, an elastomer matrix sold under the reference Geniomer 80 and corresponding to the following formula (I-1):

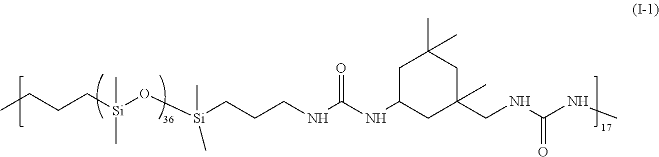

was used.

To do this, 5 g of elastomer matrix of formula (I-1) and 538 mg of polymer material of formula (II-1) as prepared in Example 1.1 above were dissolved in 20 ml and 2 ml of THF respectively. After stirring for one hour, the solution containing the polymer material of formula (II-1) was added to that containing the elastomer matrix of formula (I-1) and then the resulting mixture was left stirring for 3 hours. After complete homogenization, the resulting mixture was transferred into a mould making possible the slow evaporation of the solvent. The mould was left under a ventilated hood for 24 h and then the mixture was dried under vacuum (10⁻³ mbar) at 70° C. for 2 days in order to obtain a healing composition C1.

### Example 2: Preparation of a Self-Healing Composition C2 in Accordance with the Invention

2.1 Preparation of a Polymer Material Corresponding to the Formula (II-2)

A polymer material of following formula (II-2):

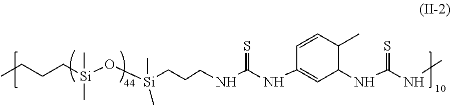

was prepared in the following way:

Toluene 2,4-diisothiocyanate (0.57 mmol) was dissolved at ambient temperature under an inert atmosphere (N₂) in 20 ml of anhydrous THF in a round-bottomed reaction flask. Then, a polydimethylsiloxane substituted in the end positions by 3-aminopropyl (FluidNH40d; 0.60 mmol) was dissolved in 18 ml of anhydrous THF and the resulting solution was added to the round-bottomed flask using a syringe driver (with a flow rate of 1.3 ml/h). The resulting solution was stirred for 17 hours. The completion of the reaction was confirmed by infrared spectroscopy by the disappearance of the absorption peak of the isothiocyanate. Once the reaction was finished, the product obtained was purified by precipitation from methanol (300 ml), followed by filtration and by drying under vacuum (10⁻³ mbar) at 70° C. for 2 days. 1.46 g of product were obtained (75% yield).

2.2 Preparation of an Elastomer Matrix Corresponding to the Formula (I-2)

An elastomer matrix of following formula (I-2):

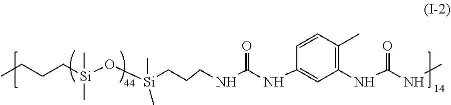

was prepared in the following way:

Toluene 2,4-diisocyanate (11.85 mmol) was dissolved at ambient temperature under an inert atmosphere (N₂) in 200 ml of anhydrous THF in a round-bottomed reaction flask, and then a polydimethylsiloxane substituted in the end positions by 3-aminopropyl (FluidNH40d; 8.98 mmol) was added to the round-bottomed flask. The resulting solution was stirred for 3 hours. An additional amount of substituted polydimethylsiloxane (2.99 mmol) dissolved in 10 ml of anhydrous THF was added using a syringe driver (with a flow rate of 1.4 ml/h). At the end of the addition, the completion of the reaction was confirmed by infrared spectroscopy by the disappearance of the absorption peak of the isocyanate. Once the reaction was finished, the product obtained was purified by precipitation from methanol (1.5 l), followed by filtration and by drying under vacuum (10⁻³ mbar) at 70° C. for 2 days. 35.68 g of product were obtained (88% yield).

2.3 Preparation of the Self-Healing Composition C2

5 g of elastomer matrix of formula (I-2) as prepared in Example 2.2 above and 520 mg of polymer material of formula (II-2) as prepared in Example 2.1 above were dissolved in 20 ml and 2 ml of THF respectively. After stirring for 1 hour, the solution containing the polymer material was added to that containing the elastomer matrix and then the resulting mixture was left stirring for 3 hours. After complete homogenization, the resulting mixture was transferred into a mould making possible the slow evaporation of the solvent. The mould was left under a ventilated hood for 24 h and then the mixture was dried under vacuum (10⁻³ mbar) at 70° C. for 2 days in order to obtain a healing composition C2.

### Example 3: Preparation of a Self-Healing Composition C3 in Accordance with the Invention

3.1 Preparation of a Polymer Material Corresponding to the Formula (II-3)

A polymer material of following formula (II-3):

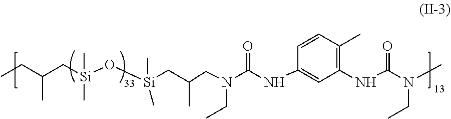

was prepared in the following way:

Toluene 2,4-diisocyanate (1 mmol) was dissolved at ambient temperature under an inert atmosphere (N₂) in 20 ml of anhydrous THF in a round-bottomed reaction flask. Then, a polydimethylsiloxane substituted in the end positions by N-ethylaminoisobutyl (DMS-A214; 1.1 mmol) was added to the round-bottomed flask. The resulting solution was stirred for 24 hours. The completion of the reaction was confirmed by infrared spectroscopy by the disappearance of the absorption peak of the isocyanate. Once the reaction was finished, the solvent was evaporated and the product obtained dried under vacuum (10⁻³ mbar) at 70° C. for 2 days. 2.6 g of product were obtained (98% yield).

3.2 Preparation of an Elastomer Matrix Corresponding to the Formula (I-3)

An elastomer matrix of following formula (I-3):

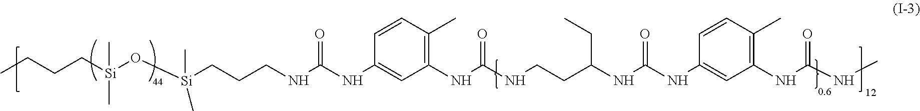

was prepared in the following way:

Toluene 2,4-diisocyanate (TDI; 7.39 mmol) was dissolved at ambient temperature under an inert atmosphere (N₂) in 200 ml of anhydrous THF in a round-bottomed reaction flask, and then a polydimethylsiloxane substituted in the end positions by 3-aminopropyl (FluidNH40d; 4.49 mmol) was added to the round-bottomed flask. The resulting solution was stirred for 4 hours. 1,3-Diaminopentane sold under the reference Dytek EP diamine (3.1 mmol) dissolved in 20 ml of dimethylformamide (DMF) was added to the round-bottomed flask using a syringe driver (with a flow rate of 1 ml/h). At the end of the addition, the completion of the reaction was confirmed by infrared spectroscopy by the disappearance of the absorption peak of the isocyanate. Once the reaction was finished, the product obtained was purified by precipitation from methanol (1.5 l), followed by filtration and by drying under vacuum (10⁻³ mbar) at 70° C. for 2 days. 13.72 g of product were obtained (85% yield).

3.3 Preparation of the Self-Healing Composition C3

4 g of elastomer matrix of formula (I-3) as prepared in Example 3.2 above and 496 mg of polymer material of formula (II-3) as prepared in Example 3.1 above were dissolved in 40 ml and 2 ml of THF respectively. After stirring for 1 hour, the solution containing the polymer material was added to that containing the elastomer matrix and then the resulting mixture was left stirring for 4 hours. After complete homogenization, the resulting mixture was transferred into a mould making possible the slow evaporation of the solvent. The mould was left under a ventilated hood for 24 h and then the mixture was dried under vacuum (10⁻³ mbar) at 70° C. for 2 days in order to obtain a healing composition C3.

### Example 4: Physicochemical Characterizations of the Self-Healing Compositions C1, C2 and C3 in Accordance with the Invention

The Young's modulus (in MPa), the breaking stress (in MPa) and the elongation at break (as %) were determined using a device sold under the trade name Instron 5565 by Instron in the following way: the values of the breaking stress and also of the elongation at break were measured directly during the breaking of the material. As regards the Young's modulus, the value was determined by analysis of the slope of the stress/strain curve, over the first 5% of strain.

The self-healing nature was demonstrated in the following way: either by visual monitoring of closure of a notch (Example 1) or by recovery of the breaking stress at a given time of a sample prenotched over half of its width (Examples 2 and 3).

Table 1 illustrated below lists the values of Young's modulus, breaking stress and elongation at break, before notching, of the compositions C1, C2 and C3, and by way of comparison of the elastomer matrices (I-1), (I-2) and (I-3) as prepared in Examples 1 to 3 above, and also the self-healing times (in hours) and self-healing percentages (as %) of the compositions C1, C2 and C3 after notching.

TABLE 1

| | self- | | | | |
|---|---|---|---|---|---|
| | healing | % | Young's | breaking | elongation |
| | time | of self- | modulus | stress | at break |
| compositions | (h) | healing | (MPa) | (MPa) | (%) |
| (I-1) | 7 | 0 | 3.8 | 2.9 | 430 |
| C1 | 7 | 85 | 1.9 | 1.9 | 470 |
| (I-2) | 24 | 0 | 1.5 | 0.73 | 790 |
| C2 | 24 | 17 | 1.5 | 0.73 | 700 |
| (I-3) | 24 | 0 | 17 | 3.3 | 200 |
| C3 | 24 | 45 | 14 | 1.7 | 70 |

The compositions have a breaking stress which can be lowered with respect to the elastomers of formula (I). However, the recovery of the breaking stress of the compositions is greater than for the elastomers (e.g. from 17% to 85% for the compositions and 0% for the elastomers). The addition of a polymer material of formula (II) thus accelerates the self-repairing kinetics of the composition, while guaranteeing good mechanical properties.

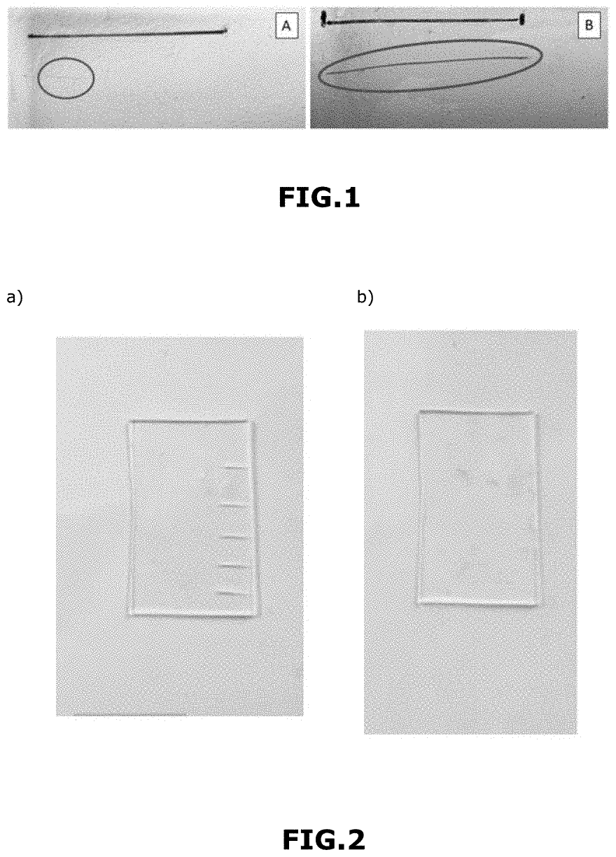

The appended FIG. 1 shows the self-healing properties of the composition C1 and by way of comparison of the elastomer I-1 when they were subjected to the following protocol: notches were produced with a cutter in layers obtained from the composition C1 (FIG. 1A) and from the elastomer I-1 (FIG. 1B), then the self-repairing was followed visually at ambient temperature as a function of the time. It is observed, after 6 days at ambient temperature, that the notch was strongly resorbed only in the case of the composition C1 (FIG. 1A). The black line represents the original size of the notch (2.5 cm).

### Example 5: Preparation of a Self-Healing Composition C4 in Accordance with the Invention

5.1 Preparation of a Polymer Material Corresponding to the Formula (II-4)

A polymer material of following formula (II-4):

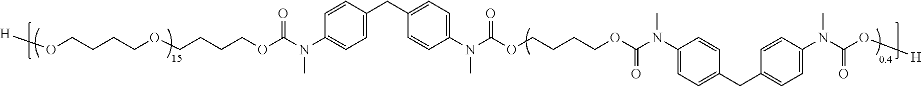

was prepared in the following way:

A commercial elastomer matrix corresponding to the following formula (I-4):

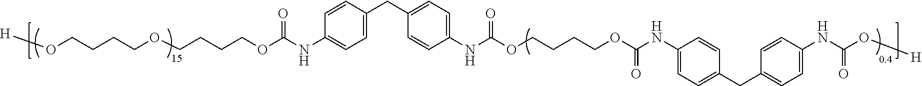

(10 g; 20.4 mmol of urethane functional group) was dissolved in 500 ml of anhydrous tetrahydrofuran (THF) in a dry round-bottomed reaction flask at ambient temperature under an inert atmosphere (argon, also subsequently denoted Ar). Sodium hydride (NaH; 1.47 g; 61.25 mmol; 60% in mineral oil) was washed twice with 30 ml of anhydrous tetrahydrofuran (THF), in order to remove the mineral oil, under an inert atmosphere (Ar), in a second dry round-bottomed reaction flask under an inert atmosphere (Ar). 50 ml of tetrahydrofuran (THF) were introduced into this round-bottomed reaction flask. The reaction medium was cooled using a bath of ice-cold water (5° C.) and then stirred under an inert atmosphere. The solution containing the elastomer matrix (I-4) was transferred by hollow needle in 40 minutes into the round-bottomed flask containing sodium hydride in THF. At the end of the addition, the bath of ice-cold water was removed and three vacuum-argon cycles were carried out in the reaction medium. After stirring for 1 hour, iodomethane (CH₃I; 4.11 ml; 66.08 mmol) was added dropwise to the reaction medium. The completion of the reaction was confirmed by proton nuclear magnetic resonance (+I NMR) by the disappearance of the peak of the N—H bonds (8.90-8.95 ppm) and the appearance of the CH₃—N peak (3.17 ppm). After stirring at ambient temperature for 3 h, the reaction was halted by the addition of methanol (MeOH; 1.51 ml; 44 mmol). Once the reaction was finished, the product obtained was purified by precipitation from water (1000 ml), followed by filtration, washing with water and drying under vacuum (10⁻³ mbar) at 40° C. for 1 day. 8.9 g of product were obtained (87% yield). The number-average molar mass (Mn) of the polymer (II-4), measured by SEC, is 63 249 g/mol.

5.2 Preparation of the Self-Healing Composition C4

15.57 g of commercial elastomer matrix of formula (I-4) as defined above and 4.67 g of polymer material of formula (II-4) as prepared in Example 5.1 above were dissolved in 150 ml and 50 ml of THF respectively. After the dissolutions had been completed with stirring, the solution containing the polymer material (II-4) was added to that containing the elastomer matrix (I-4) and then the resulting mixture was left stirring for one hour. After homogenization, the resulting mixture was transferred into several moulds making possible the slow evaporation of the solvent. The moulds were left under a ventilated hood for 24 h and then the films obtained were dried under vacuum (10⁻³ mbar) at 40° C. for 1 day in order to obtain a self-healing composition C4.

### Example 6: Preparation of a Self-Healing Composition C5 in Accordance with the Invention

6.1 Preparation of a polymer material corresponding to the formula (II-5)

A polymer material of following formula (II-5):

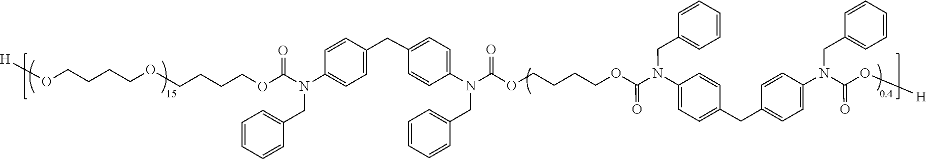

was prepared in the following way:

The elastomer matrix (I-4) as defined above (6.5 g; 13.26 mmol of urethane functional group) was dissolved in 250 ml of anhydrous tetrahydrofuran (THF) in a dry round-bottomed reaction flask at ambient temperature under an inert atmosphere (Ar). Sodium hydride (NaH; 0.987 g; 41.13 mmol; 60% in mineral oil) was washed twice with 20 ml of anhydrous tetrahydrofuran (THF), in order to remove the mineral oil, under an inert atmosphere (Ar), in a second dry round-bottomed reaction flask under an inert atmosphere (Ar). 10 ml of tetrahydrofuran (THF) were introduced into this round-bottomed reaction flask. The reaction medium was cooled using a bath of ice-cold water (5° C.) and then stirred under an inert atmosphere. The solution containing the elastomer matrix (I-4) was transferred by hollow needle in 40 minutes into the round-bottomed flask containing sodium hydride in THF. At the end of the addition, the bath of ice-cold water was removed and three vacuum-argon cycles were carried out in the reaction medium. After stirring for 1 hour, benzyl bromide (BnBr; 4.96 ml; 41.86 mmol) was added dropwise to the reaction medium. The completion of the reaction was confirmed by proton nuclear magnetic resonance (¹H NMR) by the disappearance of the peak of the N—H bonds (8.90-8.95 ppm) and the appearance of the CH₂—N peak (4.72 ppm). After stirring at ambient temperature for 40 h, the reaction was halted by the addition of methanol (MeOH; 1.2 ml; 26.5 mmol). Once the reaction was finished, the reaction medium was introduced into 300 ml of water in order to remove the salts. The mixture of reaction medium and of water is introduced into a separating funnel, into which 400 ml of dichloromethane were introduced in order to extract the organic phase. The latter was dried over MgSO₄ and concentrated. The product obtained was purified by precipitation from pentane (500 ml), followed by filtration and drying under vacuum (10⁻³ mbar) at 40° C. for 1 day. 6.50 g of product were obtained (84% yield). The number-average molar mass (Mn) of the polymer (II-5), measured by SEC, is 68 501 g/mol.

6.2 Preparation of the Self-Healing Composition C5

15.00 g of commercial elastomer matrix of formula (I-4) as defined above and 5.30 g of polymer material of formula (II-5) as prepared in Example 6.1 above were dissolved in 150 ml and 50 ml of THF respectively. After the dissolutions had been completed with stirring, the solution containing the polymer material (II-5) was added to that containing the elastomer matrix (I-4) and then the resulting mixture was left stirring for one hour. After homogenization, the resulting mixture was transferred into several moulds making possible the slow evaporation of the solvent. The moulds were left under a ventilated hood for 24 h and then the films obtained were dried under vacuum (10⁻³ mbar) at 40° C. for 1 day in order to obtain a self-healing composition C5.

### Example 7: Preparation of a Self-Healing Composition C6 in Accordance with the Invention

7.1 Preparation of a Polymer Material Corresponding to the Formula (II-6)

A polymer material of following formula (II-6):

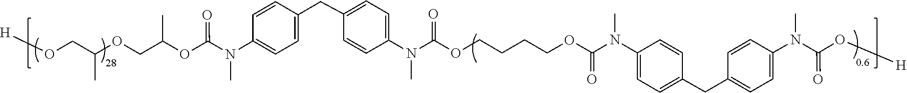

was prepared in the following way:

A commercial elastomer matrix corresponding to the following formula (I-5):

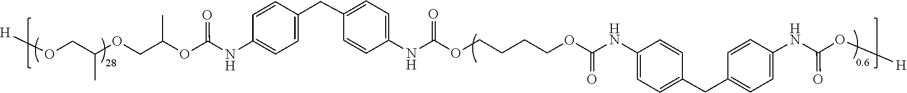

(6.02 g; 12.04 mmol of urethane functional group) was dissolved in 300 ml of anhydrous tetrahydrofuran (THF) in a dry round-bottomed reaction flask at ambient temperature under an inert atmosphere (Ar). Sodium hydride (NaH; 0.8771 g; 36.55 mmol; 60% in mineral oil) was washed twice with 20 ml of anhydrous tetrahydrofuran (THF), in order to remove the mineral oil, under an inert atmosphere (Ar), in a second dry round-bottomed reaction flask under an inert atmosphere (Ar). 10 ml of tetrahydrofuran (THF) were introduced into this round-bottomed reaction flask. The reaction medium was cooled using a bath of ice-cold water (5° C.) and then stirred under an inert atmosphere. The solution containing the elastomer matrix (I-5) was transferred by hollow needle in 40 minutes into the round-bottomed flask containing sodium hydride in THF. At the end of the addition, the bath of ice-cold water was removed and three vacuum-argon cycles were carried out in the reaction medium. After stirring for 1 hour, iodomethane (CH₃I; 2.61 ml; 41.85 mmol) was added dropwise to the reaction medium. The completion of the reaction was confirmed by proton nuclear magnetic resonance (¹H NMR) by the disappearance of the peak of the N—H bonds (8.96-9.01 ppm) and the appearance of the CH₃—N peak (3.17 ppm). After stirring at ambient temperature for 17 h, the reaction was halted by the addition of methanol (MeOH; 1.28 ml; 29.24 mmol). Once the reaction was finished, the tetrahydrofuran was evaporated. The product obtained was washed with a dichloromethane/water mixture. The organic phase was extracted with 120 ml of dichloromethane and washed three times with 120 ml of water. It was dried over MgSO₄, filtered and dried. The product drying under vacuum (10⁻³ mbar) at 40° C. for 1 day. 5 g of product were obtained (87% yield). The number-average molar mass (Mn) of the polymer (II-6), measured by SEC, is 42 095 g/mol.

7.2 Preparation of the Self-Healing Composition C6

15.56 g of commercial elastomer matrix of formula (I-4) as defined above and 4.80 g of polymer material of formula (II-6) as prepared in Example 7.1 above were dissolved in 150 ml and 50 ml of THF respectively. After the dissolutions had been completed with stirring, the solution containing the polymer material (II-6) was added to that containing the elastomer matrix (I-4) and then the resulting mixture was left stirring for one hour. After homogenization, the resulting mixture was transferred into several moulds making possible the slow evaporation of the solvent. The moulds were left under a ventilated hood for 24 h and then the films obtained were dried under vacuum (10⁻³ mbar) at 40° C. for 1 day in order to obtain a self-healing composition C6.

### Example 8: Preparation of a Self-Healing Composition C7 in Accordance with the Invention

8.1 Preparation of a Polymer Material Corresponding to the Formula (II-7)

A polymer material of following formula (II-7):

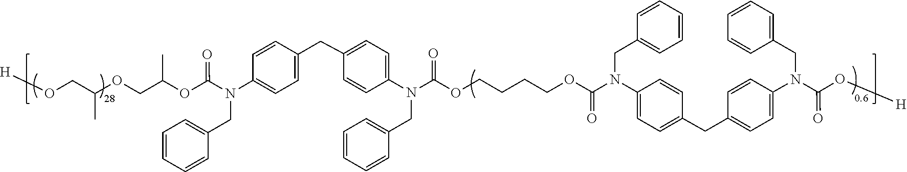

was prepared in the following way:

The elastomer matrix (I-5) as defined above (6.72 g; 13.44 mmol of urethane functional group) was dissolved in 250 ml of anhydrous tetrahydrofuran (THF) in a dry round-bottomed reaction flask at ambient temperature under an inert atmosphere (Ar). Sodium hydride (NaH; 0.9845 g; 41.02 mmol; 60% in mineral oil) was washed twice with 20 ml of anhydrous tetrahydrofuran (THF), in order to remove the mineral oil, under an inert atmosphere (Ar), in a second dry round-bottomed reaction flask under an inert atmosphere (Ar). 10 ml of tetrahydrofuran (THF) were introduced into this round-bottomed reaction flask. The reaction medium was cooled using a bath of ice-cold water (5° C.) and then stirred under an inert atmosphere. The solution containing the elastomer matrix (I-5) was transferred by hollow needle in 40 minutes into the round-bottomed flask containing sodium hydride in THF. At the end of the addition, the bath of ice-cold water was removed and three vacuum-argon cycles were carried out in the reaction medium. After stirring for 1 hour, benzyl bromide (BnBr; 4.96 ml; 41.02 mmol) was added dropwise to the reaction medium. The completion of the reaction was confirmed by proton nuclear magnetic resonance (¹H NMR) by the disappearance of the peak of the N—H bonds (8.96-9.01 ppm) and the appearance of the CH₂—N peak (4.72 ppm). After stirring at ambient temperature for 42 h, the reaction was halted by the addition of methanol (MeOH; 1.18 ml; 26.95 mmol). Once the reaction was finished, the reaction medium was introduced into 300 ml of water in order to remove the salts. The mixture of reaction medium and of water is introduced into a separating funnel, into which 450 ml of dichloromethane were introduced in order to extract the organic phase. The latter was dried over MgSO₄ and concentrated. The product obtained was purified by precipitation from pentane (450 ml), followed by filtration and drying under vacuum (10⁻³ mbar) at 40° C. for 1 day. 5.52 g of product were obtained (70% yield). The number-average molar mass (Mn) of the polymer (II-7), measured by SEC, is 41 966 g/mol.

8.2 Preparation of the Self-Healing Composition C7

14.79 g of commercial elastomer matrix of formula (I-4) as defined above and 5.11 g of polymer material of formula (II-7) as prepared in Example 8.1 above were dissolved in 150 ml and 50 ml of THF respectively. After the dissolutions had been completed with stirring, the solution containing the polymer material (II-7) was added to that containing the elastomer matrix (I-4) and then the resulting mixture was left stirring for one hour. After homogenization, the resulting mixture was transferred into several moulds making possible the slow evaporation of the solvent. The moulds were left under a ventilated hood for 24 h and then the films obtained were dried under vacuum (10⁻³ mbar) at 40° C. for 1 day in order to obtain a self-healing composition C7.

### Example 9: Physicochemical Characterizations of the Self-Healing Compositions C4, C5, C6 and C7 in Accordance with the Invention

The Young's modulus (in MPa), the breaking stress (in MPa) and the elongation at break (as %) were determined by tensile tests carried out at a rate of displacement of 30 mm/min on test specimens with a geometry of 5 A dumbbell type (ISO 527) obtained by an injection moulding process, using a device sold under the trade name Instron 5565 by Instron. The values of the breaking stress and also of the elongation at break were measured directly during the breaking of the material. As regards the Young's modulus, the value was determined by analysis of the slope of the stress/strain curve, between 1% and 1.5% of strain.

The self-healing nature was demonstrated in the following way:
either by visual monitoring of closure of a notch,
or by recovery of the breaking stress at a given time of a sample of 5 A standardized dumbbell test specimen type, cut in the middle of the working zone and then the two halves of which are directly (t<20 sec) brought back into contact manually for 2 minutes.

Table 2 illustrated below lists the values of Young's modulus, breaking stress and elongation at break, before cutting and after cutting, of the compositions C4, C5, C6 and C7, and by way of comparison of the elastomer matrices (I-4) and (I-5). Furthermore, the self-healing time (in hours) and the self-healing percentage (as %) are mentioned for each composition.

TABLE 2

| | self- | | | | |
|---|---|---|---|---|---|
| | healing | % | Young's | breaking | elongation |
| | time | of self- | modulus | stress | at break |
| compositions | (h) | healing | (MPa) | (MPa) | (%) |
| (I-4) | 168 | 0 | 5.8 | 19 | 1013 |
| (I-5) | 168 | 0 | 4.3 | 11.2 | 502 |
| C4 | 24 | 12 | 4.3 | 8 | 435 |
| C5 | 24 | 11 | 2.3 | 9.6 | 1071 |
| C6 | 24 | 22 | 1.6 | 5.8 | 660 |
| C7 | 24 | 13 | 1.6 | 5.8 | 1495 |

### Example 10: Preparation of a Self-Healing Composition C8 Comprising a Polymer Material of Formula (III)

10.1 Preparation of a Polymer Material Corresponding to the Formula (IIa-8)

A polymer material of following formula (IIa-8):

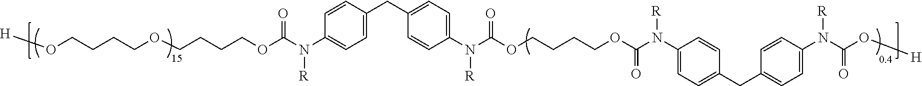

The elastomer matrix (I-4) as defined above (6.12 g; 12.48 mmol of urethane functional group) was dissolved in 250 ml of anhydrous tetrahydrofuran (THF) in a dry round-bottomed reaction flask at ambient temperature under an inert atmosphere (Ar). Sodium hydride (NaH; 0.6023 g; 25.10 mmol; 60% in mineral oil) was washed twice with 20 ml of anhydrous tetrahydrofuran (THF), in order to remove the mineral oil, under an inert atmosphere (Ar), in a second dry round-bottomed reaction flask under an inert atmosphere (Ar). 10 ml of tetrahydrofuran (THF) were introduced into this round-bottomed reaction flask. The reaction medium was cooled using a bath of ice-cold water (5° C.) and then stirred under an inert atmosphere. The solution containing the elastomer matrix (I-4) was transferred by hollow needle in 40 minutes into the round-bottomed flask containing sodium hydride in THF. At the end of the addition, the bath of ice-cold water was removed and three vacuum-argon cycles were carried out in the reaction medium. After stirring for 1 hour, iodomethane (CH₃I; 0.51 ml; 8.24 mmol) was added dropwise to the reaction medium. The completion of the reaction was confirmed by proton nuclear magnetic resonance (¹H NMR) by the decrease in the peak of the N—H bonds (8.90-8.95 ppm) and the appearance of the CH₃—N peak (3.17 ppm). After stirring at ambient temperature for 44 h, the reaction was halted by the addition of methanol (MeOH; 1.15 ml; 26.27 mmol). Once the reaction was finished, the product obtained was purified by precipitation from water (1000 ml), followed by filtration, washing with water and drying under vacuum (10⁻³ mbar) at 40° C. for 1 day. 6.19 g of product were obtained (98% yield).

The polymer (IIa-8) thus obtained statistically comprises a content of R═H at a level of 41% and of CH₃ at 59%.

10.2 Preparation of the Self-Healing Composition C8

11.49 g of commercial elastomer matrix of formula (I-4) and 4.67 g of polymer material of formula (IIa-8) as prepared in Example 10.1 above were dissolved in 150 ml and 50 ml of THF respectively. After the dissolutions had been completed with stirring, the solution containing the polymer material (IIa-8) was added to that containing the elastomer matrix (I-4) and then the resulting mixture was left stirring for one hour. After homogenization, the resulting mixture was transferred into several moulds making possible the slow evaporation of the solvent. The moulds were left under a ventilated hood for 24 h and then the films obtained were dried under vacuum (10⁻³ mbar) at 40° C. for 1 day in order to obtain a self-healing composition C8.

### Other Examples of Self-Healing Compositions

In addition to the preceding examples of compositions in accordance with the invention, other compositions have shown their self-healing properties on using similar proportions of compounds of formula (I) and (II) as described in the preceding examples.
Composition C9 comprising a compound of following formula (I):

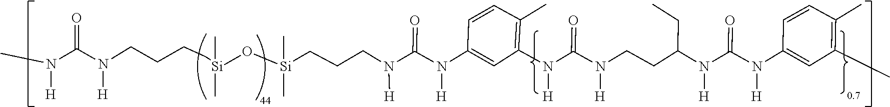

and a compound of following formula (II):

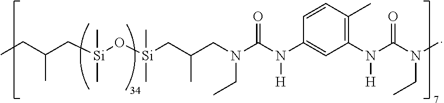

Composition C10 comprising a compound of following formula (I):

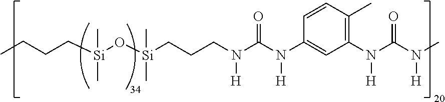

and a compound of following formula (IIa):

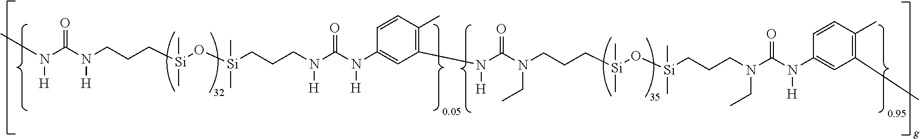

Composition C11 comprising a compound of following formula (I):

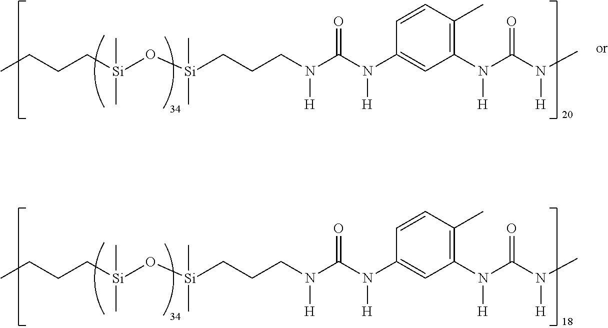

and a compound of following formula (II):

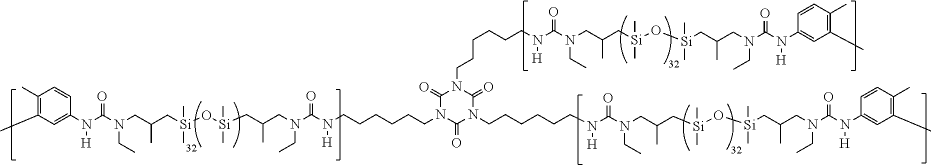

The appended FIG. 2 shows one of the self-healing compositions as defined above, which heals spectacularly after 24 hours, without external stimuli (temperature, pressure, and the like).

1. A self-healing composition comprising at least one elastomer matrix corresponding to the following formula (I): 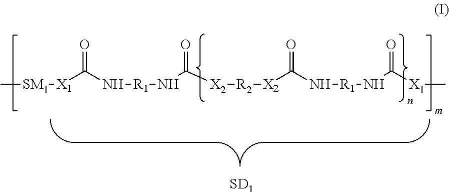
in which:
m and n are such that the molar mass of the elastomer matrix of formula (I) is between 2 and 200 kg/mol,
SM₁ is a segment chosen from polysiloxanes, polyesters, polyethers, polycarbonates and polyolefins,
said segment SM₁ being combined with a polyurea or polyurethane segment SD₁, in which:
R₁ is a divalent alkylene, arylene or aralkylene group comprising from 3 to 20 carbon atoms,
R₂ is a divalent alkylene, arylene or aralkylene group comprising from 1 to 30 carbon atoms, said group optionally comprising one or more heteroatoms chosen from an oxygen atom, a sulfur atom or a halogen atom,
X₁ and X₂, which are identical, are oxygen —O— atoms or amine —NH— groups, and
n≥0,
wherein said self-healing composition additionally comprises a polymer material corresponding to the following formula (II): 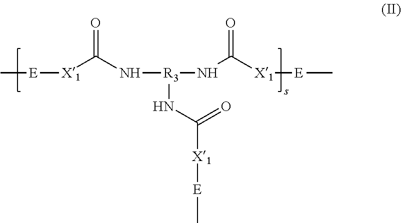
in which:
0≤s≤10,
R₃ is an at least trivalent alkylene, arylene or aralkylene group comprising from 3 to 30 carbon atoms, said R₃ group optionally comprising one or more heteroatoms chosen from an oxygen atom, a nitrogen atom and one of their mixtures, it being possible for said R₃ group to be substituted by 1, 2 or 3 additional —NH—C(═O)X′₁-E groups,
X′₁ is an oxygen —O— atom, an amine —NH— group or an amine —NR₄— group, R₄ being an alkyl group comprising from 1 to 12 carbon atoms, a benzyl group, an allyl group, or an alkylene group such that and the X₃ group as defined below together form a ring, and
E corresponds to the following formula (II′): 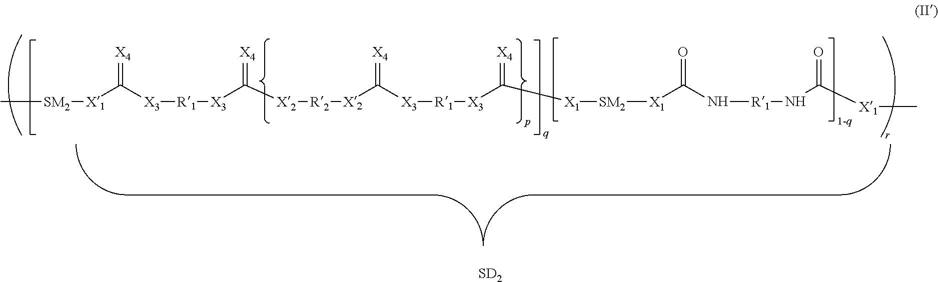
in which:
SM₂ is a segment chosen from polysiloxanes, polyesters, polyethers, polycarbonates and polyolefins,
said segment SM₂ being combined with a segment SD₂, in which:
R′₁ is a divalent alkylene, arylene or aralkylene group comprising from 3 to 20 carbon atoms,
R′₂ is a divalent alkylene, arylene or aralkylene group comprising from 1 to 30 carbon atoms, said group optionally comprising one or more heteroatoms chosen from an oxygen atom, a sulfur atom or a halogen atom,
X₁ is as defined above for the formula (I),
X′₁ is as defined above for the formula (II),
X′₂ is an oxygen —O— atom, an amine —NH— group or an amine —NR₅— group, R₅ being an alkyl group comprising from 1 to 12 carbon atoms, a benzyl group or an allyl group,
X₃ is an amine —NH— group or an amine —NR₆— group, R₆ being an alkyl group comprising from 1 to 12 carbon atoms, a benzyl group or an allyl group,
X₄ is an oxygen atom or a sulfur atom,
p≥0,
0<q≤1, and
p, q, r and s are such that the molar mass of the polymer material of formula (II) is between 1 and 200 kg/mol,
said elastomer matrix (I) and said polymer material (II) being such that:
when X₁ is an amine —NH— group, X′₁ is other than an oxygen —O— atom, X′₂ is other than an oxygen —O— atom when p≠0, and at least one of the following definitions applies:
X₄ is a sulfur atom,
X′₁ is an amine —NR₄— group,
X′₂ is an amine —NR₅— group and p≠0,
X₃ is an amine —NR₆— group,
when X₁ is an oxygen —O— atom, X′₁ is an oxygen —O— atom, X′₂ is an oxygen —O— atom when p≠0, and at least one of the following definitions applies:
X₄ is a sulfur atom,
X₃ is an amine —NR₆— group.

2. The self-healing composition comprising at least one elastomer matrix corresponding to the formula (I) as defined in claim 1 and a polymer material corresponding to the following formula (IIa): 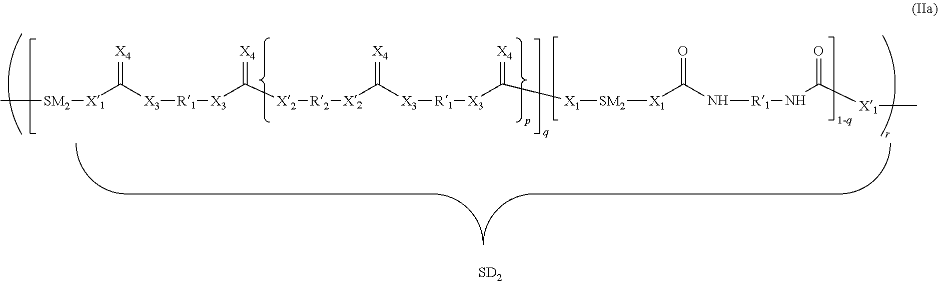
Formula (IIa) having:
SM₂,
said segment SM₂ being combined with a segment SD₂, in which:
R′₁,
R′₂,
X′₁ is an oxygen —O— atom, an amine —NH— group, an amine —NR₄— group, or a mixture of an amine —NH— group and of an amine —NR₄— group, R₄,
X′₂ is an oxygen —O— atom, an amine —NH— group, an amine —NR₅— group, or a mixture of an amine —NH— group and of an amine —NR₅— group, R₅,
X₃ is an amine —NH— group, an amine —NR₆— group, or a mixture of an amine —NH— group and of an amine —NR₆— group, R₆,
X₄ is an oxygen atom or a sulfur atom,
p,
q=1, and
p and r are such that the molar mass of the polymer material of formula (IIa) is between 1 and 200 kg/mol approximately,
said elastomer matrix (I) and said polymer material (IIa) being such that:
when X₁ is an amine —NH— group, X′₁ is other than an oxygen —O— atom, X′₂ is other than an oxygen —O— atom when p≠0, and at least one of the following definitions applies:
X′₁ is a mixture of an amine —NH— group and of an amine —NR₄— group,
X′₂ is a mixture of an amine —NH— group and of an amine —NR₅— group, and p≠0,
X₃ is a mixture of an amine —NH— group and of an amine —NR₆— group,
when X₁ is an oxygen —O— atom, X′₁ is an oxygen —O— atom, X′₂ is an oxygen —O— atom when p≠0, and X₃ is a mixture of an amine —NH— group and of an amine —NR₆— group.

3. The self-healing composition according to claim 1, wherein R₁ and R′₁, which are identical or different, are chosen from the following formulae: 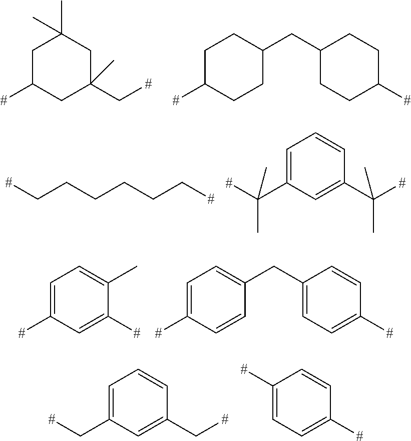
in which the # signs represent the points of attachment of the R₁ radical and of the R′₁ radical to the NH radicals and of the R′₁ radical to the X₃ radicals.

4. The self-healing composition according to claim 1, wherein R₁ and R′₁, which are identical, are chosen from the following formulae: 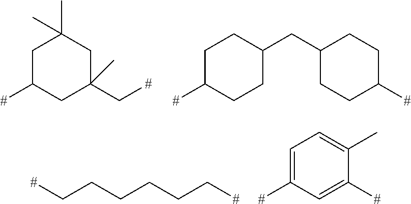
in which the # signs represent the points of attachment of the R₁ radical and of the R′₁ radical to the NH radicals and of the R′₁ radical to the X₃ radicals.

5. The self-healing composition according to claim 1, wherein:
when X′₂ is an amine —NH— and/or —NR₅— group, R′₂ is chosen from an alkylene group comprising from 2 to 12 carbon atoms and the groups having the following formulae: 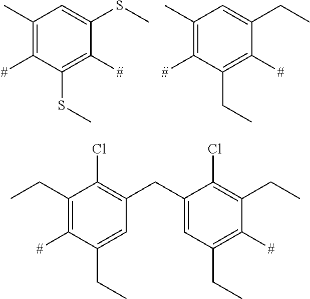
in which the # signs represent the points of attachment of the R′₂ radical to the X′₂ radicals,
when X′₂ is an oxygen —O— atom, R′₂ is chosen from an alkylene group comprising from 2 to 12 carbon atoms and the groups having the following formulae: 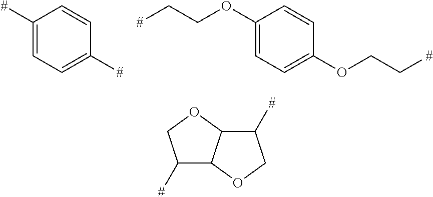
in which the # signs represent the points of attachment of the R′₂ radical to the X′₂ radicals.

6. The self-healing composition according to claim 1, wherein the segments SM₁ and SM₂ are polysiloxanes or polyethers.

7. The self-healing composition according to claim 1, wherein X₁ is an amine —NH— group, X′₁ is an amine —NH— or —NR₄— group, X₃ is an amine —NH— or —NR₆— group and X₄ is a sulfur atom.

8. The self-healing composition according to claim 1, wherein X₁ is an amine —NH— group, X′₁ is an amine —NR₄— group, X₃ is an amine —NH— or —NR₆— group and X₄ is an oxygen atom.

9. The self-healing composition according to claim 1, wherein X₁ is an oxygen —O— atom, X′₁ is an oxygen —O— atom, X₃ is an amine —NR₆— group and X₄ is an oxygen atom.

10. The self-healing composition according to claim 1, wherein R₃ is chosen from an alkylene group comprising from 3 to 24 carbon atoms and the groups having the following formulae: 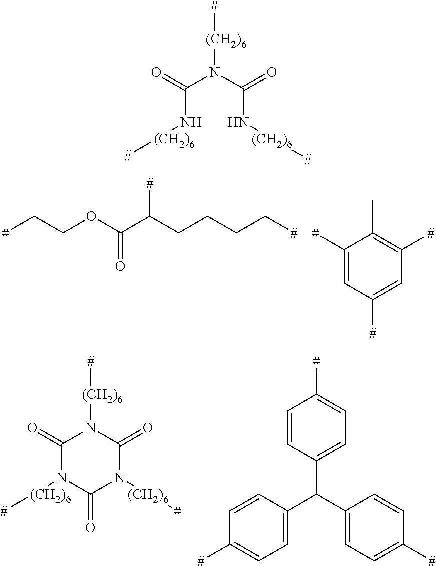
in which the # signs represent the points of attachment of the R₃ radical to the —NH— radicals.

11. The self-healing composition according to claim 1, wherein the ratio: molar mass segment SD₂/(molar mass segment SD₂+molar mass segment SM₂), varies from 0.01 to 0.6.

12. The self-healing composition according to claim 1, wherein:
when X₂ is an amine —NH— group, R₂ is chosen from an alkylene group comprising from 2 to 12 carbon atoms and the groups having the following formulae: 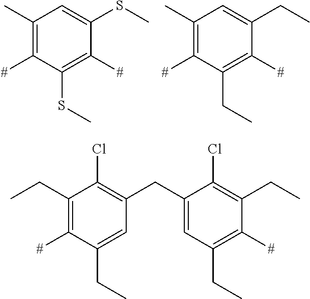
in which the # signs represent the points of attachment of the R₂ radical to the X₂ radicals,
when X₂ is an oxygen —O— atom, R₂ is chosen from an alkylene group comprising from 2 to 12 carbon atoms and the groups having the following formulae: 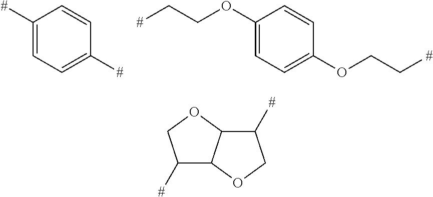
in which the # signs represent the points of attachment of the R₂ radical to the X₂ radicals.

13. The self-healing composition according to claim 1, wherein the ratio: molar mass segment SD₁/(molar mass segment SD₁+molar mass segment SM₁) in the elastomer (I), varies from 0.01 to 0.6.

14. The self-healing composition according to claim 1, wherein the composition additionally comprises at least one inorganic filler.

15. The self-healing composition according to claim 1, wherein the polymer material (II) or (IIa) represents from 0.1% to 100% by weight, with respect to the total weight of the elastomer matrix (I).

16. A process for the preparation of a composition as defined in claim 1, wherein said process comprises at least one stage of mixing the elastomer (I) with the polymer material (II) or (IIa), by the solvent route or by the molten route.

17. A healing additive for an elastomer for an elastomer corresponding to the formula (I), wherein said healing additive comprises at least a polymer material corresponding to the formula (II) or (IIa), said formulae (II) and (IIa) as defined in claim 1.

18. An ambient temperature self-healing material, said ambient temperature self-healing material comprises at least said self-healing composition as defined in claim 1.

19. A seal, coating, vibration damping material, and/or an insulating material for an electrical and/or optical cable, comprising: a self-healing composition as defined in claim 1.

20. An electrical and/or optical cable comprising at least one electrical and/or optical conducting element and at least one polymer layer surrounding the electrical and/or optical conducting element, wherein the polymer layer is obtained from a self-healing composition as defined in claim 1.

21. A healing additive, wherein said healing additive is a polymer material corresponding to the formula (II) as defined in claim 1 and in which X′₁ is an amine N-ethyl, N-benzyl or N-allyl group, X₃ is an amine —NH— group, SM₂ is a polydimethylsiloxane segment and X₄ is an oxygen atom.
